(19) United States
(12) Patent Application Publication
(10) Pub. No.: US 2002/0163984 A1
(43) Pub. Date: Nov. 7, 2002

(54) Clock and data recovery unit based on class B amplifier

(76) Inventors: Vladimir V. Katzman, Rancho Palos Verdes, CA (US); Richard Nottenburg, Princeton, NJ (US); Yaozhong Liu, Torrance, CA (US); David Scott Farkas, Hermosa Beach, CA (US); Loc Binh Chau, Canoga Park, CA (US); Andrew John Bonthron, Los Angeles, CA (US); Christopher Joseph Clark, Hermosa Beach, CA (US)

Correspondence Address: PENINSULA IP GROUP, A Professional Law Corporation, 2290 North First Street, San Jose, CA, 95131, US

(21) Appl. No.: 09/849,581

(22) Filed: May 3, 2001

(51) Int. Cl. H04L 7/00

(52) U.S. Cl. 375/355; 375/340

(57) ABSTRACT

Apparatus and method for recovering clock and data signals from received transmission line information and for regenerating the recovered clock and data signals. The apparatus comprises a clock detector for recovering and generating a clock signal from the received transmission line information and a data detector for recovering and regenerating data contained in the received transmission line information and directional coupling apparatus for magnetically coupling the received transmission line information with the clock and data circuitry.

### FIELD OF THE INVENTION

The present invention relates to digital data communication apparatus and in particular to high sensitivity and low power consumption apparatus and to a method for recovering clock and data signals transmitted on optical fiber transmission lines.

### BACKGROUND OF THE INVENTION

High speed digital and optical communication systems are widely installed in many areas of the United States. These types of communication systems generally have transmitter/receiver apparatus and a transmission facility or line interconnecting the transmitter/receiver apparatus to provide a path over which data may be exchanged between the transmitter/receiver apparatus. Increasing advances in technology and the need for more information require greater speed in the rate of transmitting data. The technology has went from analog systems to digital information systems capable of transmitting digital information in the form of logical “0's” and “1's” often times referred to as bits. In an effort to increase the speed of transmission systems, the technology has advanced to the use of optical transmission systems using optical transmitter/receivers interconnected by optical transmission facilities such as optical fibers that transmit optical pulse bit information between the optical transmitter/receivers.

Digital transmitters and receivers are oftentimes connected by long transmission facilities. Typically, a digital transmitter applies binary digital signal information to the transmission facility which is then sent to the receiver which is designed to receive and decode data contained within the received information. The characteristics of the transmission line often times deforms the waveform format of the transmitted information such that the transmitted information is meaningless when it is received by the distant receiver. Thus, digital and optical transmission systems oftentimes have transmitter/receiver devices connected by transmission facilities which may have optical clock and data regenerative units or repeaters located in the transmission facilities between the transmitters and receivers. The clock and data regenerative recovery units are used to restore data transmitted through long transmission facilities.

In order to have high quality of the data with a minimal bit error rate it is important to minimize data signal losses when delivering wide band and high-speed data to the transmitters and receivers. It is also important to maintain the same clock signal versus data signal delay over a wide range of amplitude variations of the incoming data information and to preserve a good return loss in the transmission facility. Thus, there is a problem in high speed and wide band data transmission facilities in that it is important to minimize data signal loss, avoid clock phase variations in clock recovery units and to reduce power consumption when using high-density wave division multiplexer techniques.

### SUMMARY OF THE INVENTION

It is an object of the invention to provide apparatus for recovering clock and data signals from transmission line information wherein the apparatus has low power directional coupler circuitry having magnetically coupled microstrip lines coupled with a transmission line for receiving the transmission line information appearing on the transmission line and coupling the received transmission line information with clock and data detectors for recovering clock and regenerating data signals from the received transmission line information.

It is also an object of the invention to provide a central processor controlled magnetic delay line for varying a phase of clock signals regenerated from received transmission line information.

It is also an object of the invention to provide a clock detector magnetic directional coupler for receiving spectral power density signals defining clock signals from transmission line information and magnetically coupling the spectral power density signals to the input of a clock detector peak detector for determining an absence of the magnetically generated spectral power density signals as a loss of transmission line information indication.

It is also an object of the invention to provide a data detector magnetic directional coupler for connecting regenerated clock signals to a memory element connected to a transmission line and to a central processor unit for recovering and regenerating data received from a transmission line and for magnetically coupling the regenerated clock signals with a peak detector for detecting an absence of magnetically induced clock signals and signaling the central processor unit the absence of the regenerated clock signals as a loss of clock signal.

In a preferred embodiment of the invention, apparatus recovers and generates clock and data signals from received transmission line information. The apparatus has clock detector components for recovering and generating a clock signal from the received transmission line information and data detector components enabled by the recovered clock signal for recovering and generating data contained in the received transmission line information. Magnetically coupled microstrip line directional coupler apparatus couples the transmission line with the clock and data detector components to receive the transmission line information and regenerate the clock and data in the received transmission line information. A magnetically coupled microstrip delay line component of the clock detector apparatus provides a phase shift of the regenerated clock information.

Also in accordance with the preferred embodiment of the invention, recovering and generating clock and data signal apparatus has directional coupling apparatus with a pair of magnetically coupled microstrip transmission lines positioned in a parallel relationship for magnetically coupling a transmission line to data and clock detector apparatus. A class B narrow band amplifier connected to one of the directional coupling microstrip transmission lines receives magnetically coupled transmission line information and amplifies positive and negative pulses of the received transmission line information as a distorted sine wave. Circuitry connected to the output of the class B band amplifier defines spectral power density signals corresponding to a clock rate of the received transmission line information and defines clock signals from the distorted sine wave. A clock detector directional coupler coupled to a peak detector and having magnetically coupled microstrip transmission lines receives the defined clock signals and magnetically couples the defined clock signals to the peak detector for determining an absence of the magnetically coupled defined clock signals as a loss of transmission line information indication. A variable magnetic delay line and narrow band amplifier connected to the clock detector directional coupler has a pair of magnetically coupled microstrip transmission lines with one microstrip transmission line having an input port for receiving the defined clock signals and a through port connected through a first varactor diode to ground. Another microstrip transmission line has a coupled port connected through a second varactor diode to ground and an isolated port output. A network having one end connected to the through port of the one microstrip transmission line and an opposite end connected to the isolated port of the other microstrip transmission line enables signals applied to a center point of the series network by a central processor unit to vary the phase of the received clock signals. A combination of a narrow band amplifier coupled to a narrow band filter with the amplifier and filter combination having an input connected to the isolated port output of the variable magnetic delay line amplifies the phase varied clock signals and eliminates high order harmonics appearing therein. Data detecting circuitry has a memory device with one input connected to the directional coupler other microstrip transmission line for receiving the transmission line information output of the directional coupling apparatus and has another input for receiving control signals determining magnitudes for recording the transmission line information. The data detector memory device regenerates data signals from the received transmission line information in response to the recovered clock signals. A clock signal detecting directional coupler has a pair of magnetically coupled microstrip transmission lines one of which receives the recovered clock signals and applies the received recovered clock signals to a clock input of the memory device and another one of the microstrip transmission lines which magnetically couples the recovered clock signals to a peak detector for detecting an absence of magnetically induced clock signals as a loss of clock signal.

Also in accordance with the preferred embodiment of the invention, clock detector apparatus of clock and data signal recovery and generating apparatus has a magnetic delay line having a pair of magnetically coupled microstrip transmission lines positioned in a parallel relationship with one microstrip transmission line having an input port for receiving the clock signals and a through port connected through a first varactor diode to ground. Another microstrip transmission line positioned in a parallel relationship with respect to the one microstrip transmission line has a coupled port connected through a second varactor diode to ground and an isolated port output. A network has one end connected to the through port of the one microstrip transmission line and an opposite end connected to the isolated port of the other microstrip transmission line for enabling signals applied to the network to vary the phase of the received clock signals.

Also in accordance with the preferred embodiment of the invention, a method for recovering and generating clock and data signals from received transmission line information comprises the steps of coupling the received transmission line information to a data detector and regenerating data appearing in the received transmission line information and magnetically coupling the received transmission line information to a class B amplifier coupled to a clock detector and recovering clock signals used to generate data in the transmission line information.

### BRIEF DESCRIPTION OF THE DRAWINGS

For a further understanding of the objects and advantages of the present invention, reference should be had to the following detailed description, taken in conjunction with the accompanying drawing figures, in which like parts are given like reference numerals and wherein:

FIG. 1 is a block diagram of clock and data recovery apparatus in accordance with principles of the invention,

FIG. 2 is a diagram of the microstrip line directional coupler of the clock and data recovery apparatus set forth in FIG. 1 for coupling transmission line information with the clock and data detectors,

FIG. 3 is a block diagram of the components of the clock detector apparatus set forth in FIG. 1,

FIG. 4 is a block diagram of the components of the data detector apparatus set forth in FIG. 1,

FIG. 5 is a diagram of the microstrip delay line component set forth in the clock detector set forth in FIGS. 1 and 3,

FIG. 6 is a diagram of the microstrip line directional coupler of the data detector apparatus set forth in FIGS. 1 and 4, and

FIG. 7 is a diagram of the microstrip line directional coupler of the clock detector apparatus set forth in FIGS. 1 and 3.

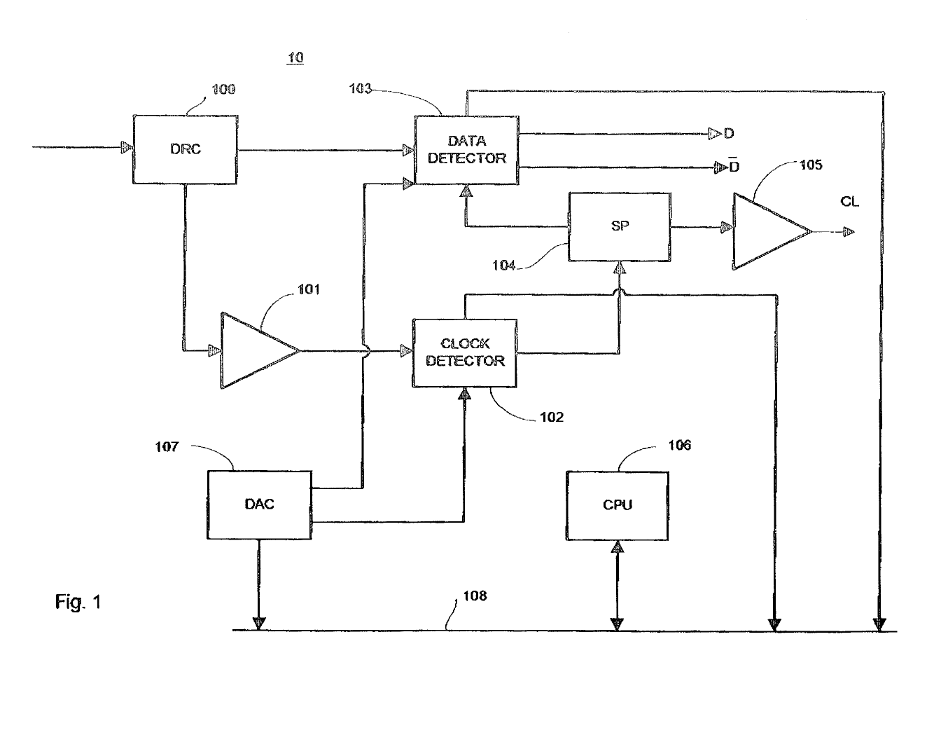

The detailed logic circuitry of the clock and data recovery apparatus set forth in FIGS. 1 through FIG. 5 of the drawing is performed by amplifiers, logic gates, flip flops, narrow band splitters, peak detectors, filters, digital-to-analog converters and central processor units, the individual operation of which are well known in the art and the details of which need not be disclosed for an understanding of the invention. Typical examples of the logic circuitry are described in numerous textbooks. For example, such types of logic circuitry, among others, are described by J. Millman and H, Taub in Pulse, Digital and Switching Waveforms, 1965, McGraw-Hall, Inc., H. Alex Romanowitz and Russell E. Puckett in Introduction to Electronics, 1968, John Wiley & Sons, Inc. and in The TTL Data Book for Design Engineers, Second Edition, 1976, Texas Instruments Incorporated. Background information on digital transmission on fiber optics may be found on text books by P. Bylanski and D. Ingram, Digital Transmission Systems, 1980, Peter Peregrius Ltd, K. Murata et al., IEE Electron Letters, 1988, and Fiber Optics Communication Systems, 1992, John Wiley & Sons, Inc.

### DETAILED DESCRIPTION OF THE INVENTION

With particular reference to FIG. 1, there is shown clock and data signal recovery and generating apparatus 10, in accordance with the principles of the invention, for use in a digital data transmission system such an optical communication transmission system to recover clock and data signals received as transmission line information over an optical fiber or other path of a transmission facility. Apparatus 10 recovers and regenerates clock and data signals from the received transmission line information for retransmission by a repeater over another optical fiber or for use by a receiver unit connected to the transmission facility. In addition, clock and data signal recovery and generating apparatus 10 detects a loss of the received transmission line information and clock signal. Although digital information in the form of logical “0's” and “1's” is transmitted on the transmission facility, the characteristics of the transmission facility deforms the format of the transmitted line information thereby requiring that the information received on a long transmission facility be regenerated before being retransmitted on another transmission facility or applied to a receiver.

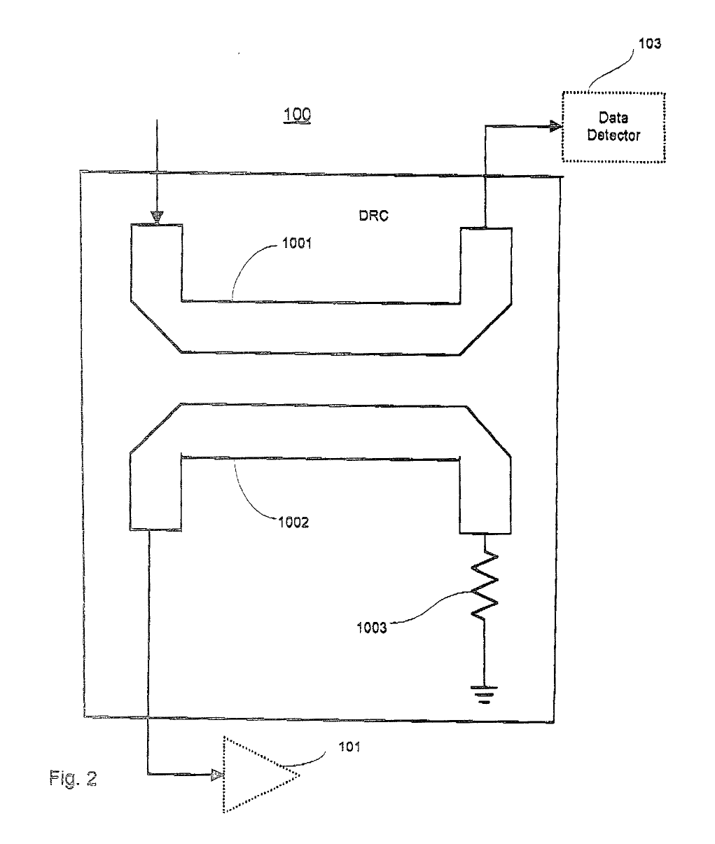

The information on an incoming transmission facility is received at a magnetic coupler 100, FIG. 1, of the clock and data signal recovery and generating apparatus 10 and applied over two output ports one of which is connected to a class B amplifier 101 and the clock detector 102 and the other connected to data detector 103. Directional coupler 100, FIG. 2, has a pair of magnetically coupled microstrip transmission lines 1001, 1002 coupled with the transmission line for detecting and receiving the transmission line information and for applying the received information to the clock and data detectors 102, 103. Microstrip transmission lines 1001 and 1002 are generally rectangular members, although not necessarily limited to this configuration, positioned in a parallel relationship for magnetically coupling the transmission line information received on one microstrip transmission line 1001 to the other microstrip transmission line 1002. The amount of magnetic coupling is set by the spacing of microstrip transmission line 1001 with respect to microstrip transmission line 1002 and by the width and length of both microstrip transmission lines 1001, 1002. In operation, the received transmission line information is applied as an input to microstrip transmission line 1001 and flows through microstrip transmission line 1001 to an output coupled with data detector 103. The energy flowing in microstrip transmission line 1001 is magnetically coupled by magnetic fields generated by the energy flowing in microstrip transmission line 1001 to microstrip transmission line 1002 thereby causing energy to flow through resistor 1003 and microstrip transmission line 1002 to the input of amplifier 101. The spacing and dimensions of microstrip transmission lines 1001 and 1002 are such that the magnetic coupling is relatively narrow band so that the coupled waveform is a differentiated version of the input transmission line information. Similar results for differential bit rates of transmission line information are obtained by modifying the dimensions of the microstrip transmission lines 1001 and 1002.

Directional coupler 100 has microstrip transmission line 1002 coupled to the input of class B narrow band amplifier 101 such magnetically induced signals generated by the signals in microstrip transmission line 1001 flow from ground through resistor 1003 and the output of microstrip transmission line 1002 to class B amplifier, FIG. 1. Class B amplifier 101 in the well-known manner amplifies only part of the positive and negative pulses appearing at the output of directional coupler 100. Thus, class B narrow band amplifier 101 having an input connected to one of the microstrip transmission lines 1002 receives the magnetically coupled transmission line information and amplifies positive and negative pulses of the received transmission line information and applies the amplified pulses as a distorted sine wave to the clock detector 102.

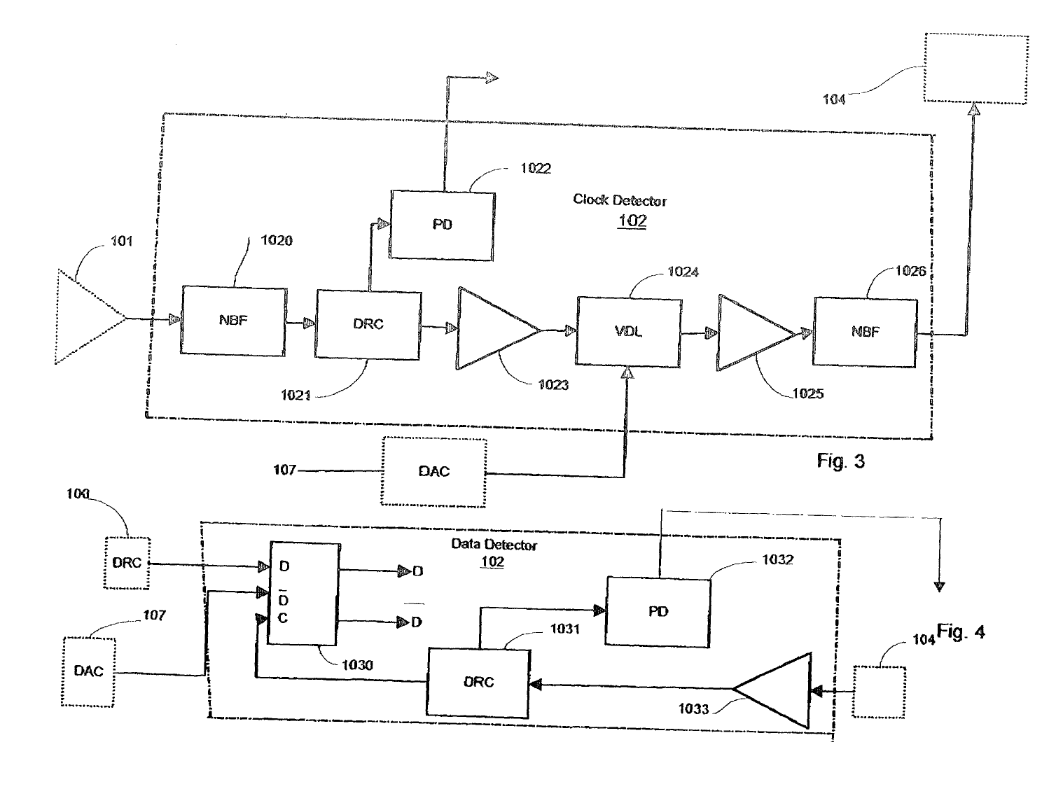

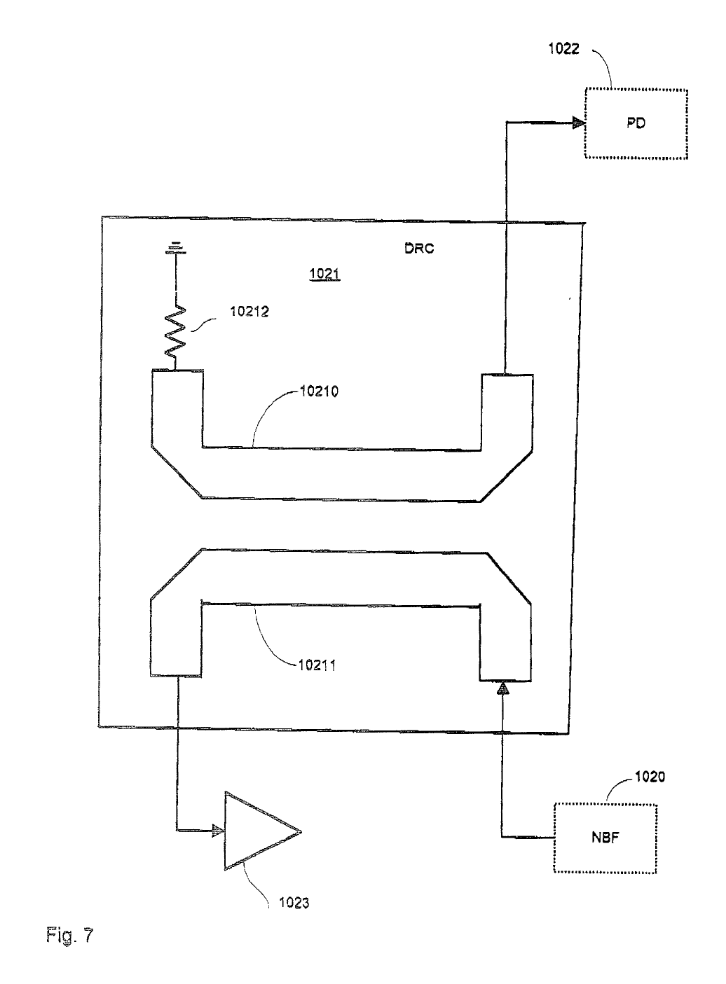

Clock detector 102, FIG. 3, has a narrow band pass filter 1020 connected to the output of the class B band amplifier 101 and limits the frequencies of the applied distorted sine wave pulses to signals defining a spectral power density corresponding to the clock rate of the received transmission line information. Narrow band pass filter 1020 has a quality Q of 1000 to limit the noise that may appear in the input signal. The clock detector 102 also has a clock detector magnetic directional coupler 1021, FIG. 7, having a pair of magnetically coupled microstrip transmission lines 10210 and 10211 positioned in a parallel relationship for receiving the spectral power density signals from the narrow band pass filter 1020. The output signals of the narrow band output filter 1020 are applied to the input of microstrip transmission line 10211 having an output connected to the input of amplifier 1023.

As earlier set forth for directional coupler 100, FIG. 2, the construction and dimensions of the microstrip lines 10210 and 10211, FIG. 7, are such that the signals appearing on microstrip line 10211 generate magnetic fields that in turn generate signals in microstrip line 10210 that flow from ground and through resistor 10212 and microstrip transmission line 10210 to the input of peak detector 1022. The output of peak detector 1022, FIG. 3, is a DC voltage proportional to the amplitude of the input signal. The output DC signal is applied to bus 108, FIG. 1, and central processor unit 106 and represents the presence of the incoming transmission line information. Thus, peak detector 1022, connected to the one magnetic coupler microstrip transmission line 10210, FIG. 7, receives a magnetically generated signal of the directional coupler 1021, FIG. 3, received spectral power density signals and determines an absence of the magnetically generated signals as a loss of transmission line information. The other output of the clock detector 102 directional coupler 1021, FIG. 3, is applied to a narrow band amplifier 1023 having an input connected to the output of microstrip transmission line 10211, FIG. 7, and generates the clock signals in response to receipt of the spectral power density information output of directional coupler 1021.

The clock signals are applied to the input of variable magnetic delay line 1024, FIG. 5. The variable magnetic delay line 1024 has a pair of magnetically coupled microstrip transmission lines 10240 and 10241 with one microstrip transmission line 10240 having an input port connected to an output of the narrow band amplifier 1023 for receiving the clock signal. A through port of microstrip transmission line 10240 is through a first varactor diode 10244 to ground such that the clock signals from narrow band amplifier 1023 flow through capacitor 10243, microstrip transmission line 10240 and varactor 10244 to ground. The clock signals generate magnetic fields that cause clocks signals to flow in microstrip transmission line 10241. The coupled port of microstrip transmission line 10241 is connected through varactor 10245 to ground and the isolated port output is coupled via capacitor 10246 to the input of a narrow band amplifier 1025. The through port of microstrip transmission line 10240 is connected to one end of a network 10242 having another end connected to the isolated port of microstrip transmission line 10241. Central processor unit 106, FIG. 1, applies digital signals on bus 108 to digital-to-analog converter 107 that responds to the computer generated signals by applying varying voltages to network 10242, FIG. 5, to vary the phase of the magnetically induced clock signals applied to the input of narrow band amplifier 1025. Magnetic delay line 1024 splits the input clock signals between the through and coupled ports of the microstrip transmission lines 10240 and 10241. By using varactor diodes 10244 and 10245 for terminating the through port of microstrip transmission line 10240 and the coupled port of microstrip transmission line 10241, respectively, the clock signals are reflected and recombine in-phase at the isolated port output of microstrip transmission line 10241. Thus, the central processor unit 106, FIG. 1, by varying the phase adjust voltage applied to a center point of network 10242, FIG. 5, obtains a delay or phase shift of the clock signal due to the changing capacitance of the varactor diodes 10245 and 10244.

A combination of a narrow band amplifier 1025, FIG. 3, coupled to a narrow band filter 1026 has an input connected to the isolated port output of the variable magnetic delay line 1024 and amplifies the clock signal output of magnetic delay line 1024 and eliminates any high order harmonics appearing in the clock signal input. The clock signal output of narrow band filter 1026 is applied to a narrow band splitter circuit 104, FIG. 1, having an input connected to the output of the clock detector narrow band filter 1026. The splitter circuit 104 applies the split cock signals to data detector 103 and to amplifier 106 which amplifies the regenerated clock signals CL. Although not shown, the regenerated clock pulses CL may be provided to central processor unit 106 or other repeater or receiver apparatus.

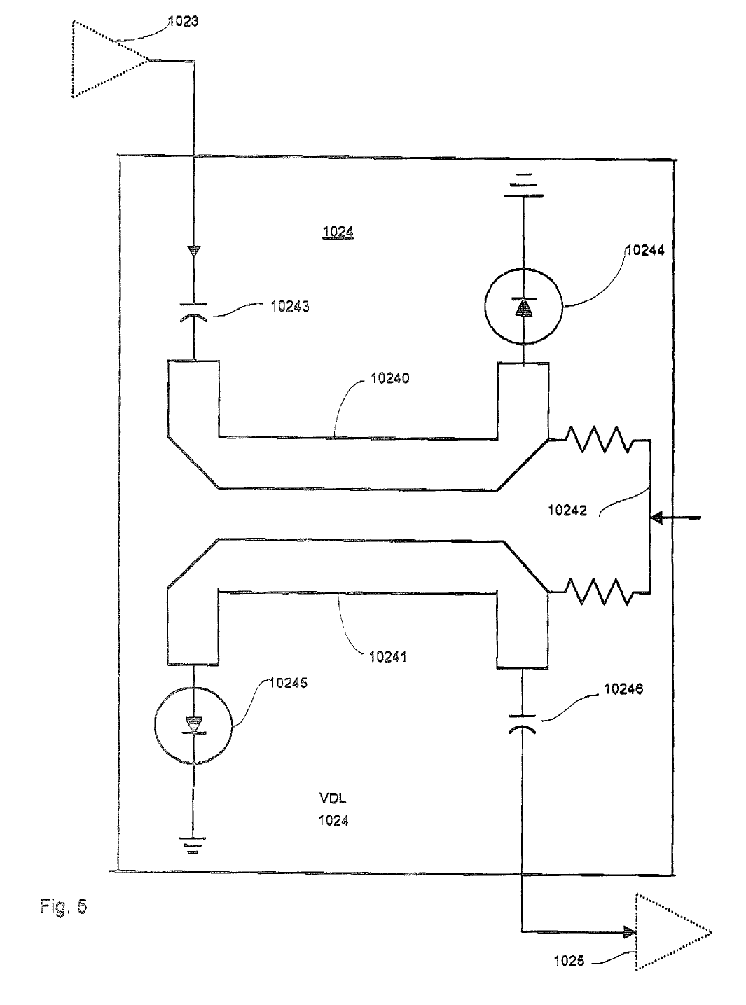

The transmission line information applied to directional coupler 100, FIG. 1, is coupled by the directional coupler microstrip transmission line 1001, FIG. 2, to the input of data detector 103.and in particular to the D input of flip-flop 1030, FIG. 4. On the transmission line facility coupled with clock and data signal recovery and generating apparatus 10, there may also be undesirable noise combined with the transmitted transmission line information. Typically, the noise appearing at the D input of the flip-flop 1030 of data detector 103 is at different voltage levels than that of the received transmission line information. Thus, central processor unit 108, FIG. 1, is programmed to distinguish between noise and valid information appearing in the received transmission line information by applying different levels of voltage to the data detector flip-flop 1030, FIG. 4. The voltage level information is transmitted as digital information on bus 108, FIG. 1, by central processor unit 106 addressed to the digital-to-analog circuit 107. The digital-to-analog unit 107 converts the digital information into analog voltages which are then applied to the \check{D} input of flip-flop 1030, FIG. 4, in order that flip-flop 1030 may distinguish between noise and data signals appearing in the incoming transmission line information.

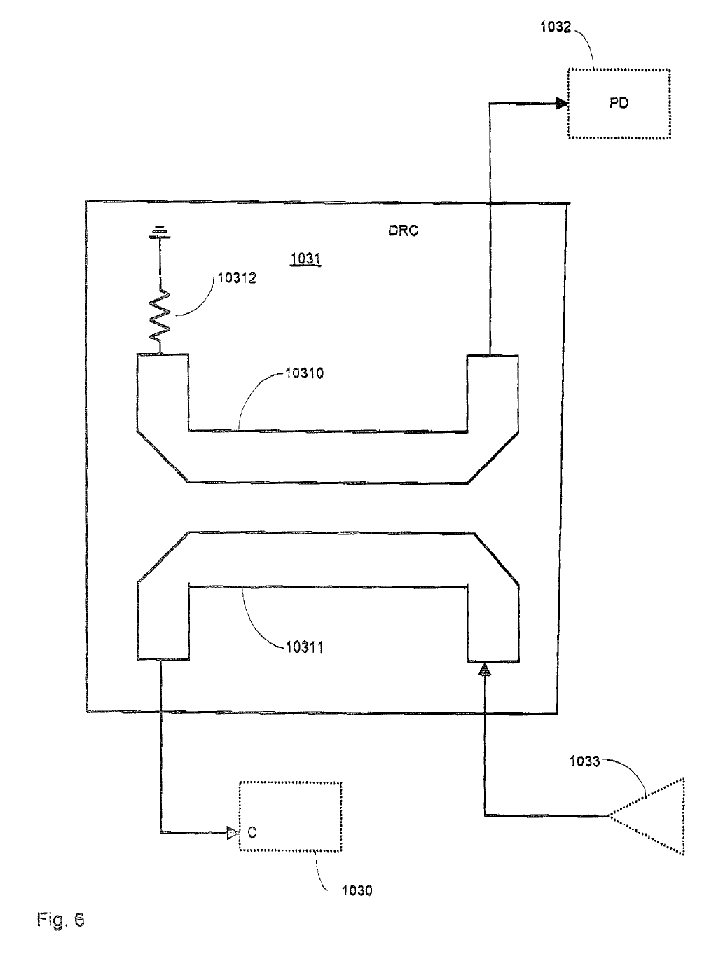

Clock signals incoming from narrow band splitter circuit 104 are amplified by amplifier 1033 and applied to data detector directional coupler 1031, FIG. 6. Data detector directional coupler 1031 has a pair of magnetically coupled microstrip transmission lines 10310 and 10311. Microstrip transmission line 10311 receives the clock signals amplified by the data detector amplifier 1033 and applies the amplified clock signals to the clock input C of flip-flop 1030 to regenerate the data signals in the received transmission line information. The clock signals received by microstrip transmission line 10311 produce magnetic fields that generate clock signals in microstrip transmission line 10310 that flow from ground through resistor 10312 and microstrip transmission line 10310 to the input of peak detector 1032, FIG. 4. Peak detector 1032 determines that the receipt of the magnetically induced clock signals indicates the presence of clock signals in producing the incoming transmission line information and that the absence of the regenerated clock signals is a loss of clock signal LOS.

In a transmission system, information is transmitted from a transmitter over a transmission facility or line to a receiver. On a long transmission line there may be a need for a repeater located within or at the end of the transmission line to recover and generate clock and data signals from the transmission line information. In accordance with the principles of the instant invention, a method for recovering and generating clock and data signals from received transmission line information has the steps of coupling the received transmission line information to a data detector and regenerating data appearing in the received transmission line information. The received transmission line information is magnetically coupled to the input of a class B amplifier coupled to a clock detector for recovering clock signals used to generate data in the transmission line information.

It is obvious from the foregoing that the facility, economy and efficiently of optical and digital transmission systems is improved by apparatus for recovering and generating clock and data signals from received transmission line information with a high sensitivity and low power consumption by the use of magnetic directional couplers. While the foregoing detailed description has described an embodiment of clock and data signal recovery and generating apparatus and a method of operation thereof in accordance with principles of the invention, it is to be understood that the above description is illustrative only and is not limiting of the disclosed invention. Particularly other configurations of time delay, digital-to-analog and control apparatus are within the scope and spirit of this invention. Thus, the invention is to be limited only by the claims set forth below.

What is claimed is:

1. Apparatus for recovering and generating clock and data signals from information received on a transmission line comprising
clock detecting means for recovering and generating a clock signal from the received transmission line information;
data detecting means enabled by the recovered clock signal for recovering and generating data contained in the received transmission line information; and
directional coupling means having magnetically coupled microstrip lines coupled with the transmission line for receiving the transmission line information and with the clock and data detecting means for applying the received transmission line information to the clock and data detecting means.

2. The clock and data signal recovery and generating apparatus set forth in claim 1 wherein the directional coupling means comprises;
a pair of magnetically coupled microstrip transmission lines positioned in a parallel relationship with one microstrip transmission line for receiving and applying the transmission line information to the data detecting means and for magnetically coupling the received transmission line information to the other microstrip transmission line for transmission to the clock detecting means.

3. The clock and data signal recovery and generating apparatus set forth in claim 2 further comprising;
a class B narrow band amplifier having an input connected to the other microstrip transmission line for receiving the magnetically coupled transmission line information and amplifying positive and negative pulses of the received transmission line information and applying the amplified pulses as a distorted sine wave to the clock detecting means.

4. The clock and data signal recovery and generating apparatus set forth in claim 3, wherein the clock detecting means comprises;
a narrow band filter connected to an output of the class B narrow band amplifier for limiting frequencies of the amplified pulses of the distorted sine wave to signals defining a spectral power density corresponding to a clock rate of the received transmission line information.

5. The clock and data signal recovery and generating apparatus set forth in claim 4, wherein the clock detecting means comprises;
a clock detecting means magnetic directional coupler having a pair of magnetically coupled microstrip transmission lines positioned in a parallel relationship for receiving the spectral power density signals from the narrow band filter.

6. The clock and data signal recovery and generating apparatus set forth in claim 5, wherein the clock detecting means comprises;
a peak detector connected to one of the magnetic coupler microstrip transmission lines for receiving a magnetically generated signal of the coupler received spectral power density signals and for determining an absence of the magnetically generated signal as a loss of transmission line information indication.

7. The clock and data signal recovery and generating apparatus set forth in claim 6, wherein the clock detecting means comprises;
a narrow band amplifier having an input connected to an output of the other magnetic coupler microstrip line for generating the clock signals in response to receipt of the spectral power density information.

8. The clock and data signal recovery and generating apparatus set forth in claim 7, wherein the clock detecting means comprises;
variable magnetic delay means connected to an output of the narrow band amplifier for varying a phase of the clock signal generated from the spectral power density information.

9. The clock and data signal recovery and generating apparatus set forth in claim 8, wherein the variable magnetic delay means comprises;
a pair of magnetically coupled microstrip transmission lines with one microstrip transmission line having an input port connected to an output of the narrow band amplifier for receiving the clock signal and a through port connected through a first varactor diode to ground and with another microstrip transmission line having a coupled port connected through a second varactor diode to ground and an isolated port output.

10. The clock and data signal recovery and generating apparatus set forth in claim 9, wherein the variable magnetic delay means comprises;
a network having one end connected to the through port of the one microstrip transmission line and an opposite end connected to the isolated port of the other microstrip transmission line such that signals applied to a center point of the series network varies the phase of the clock signal.

11. The clock and data signal recovery and generating apparatus set forth in claim 10, wherein the clock detecting means comprises;
a combination of a narrow band amplifier coupled to a narrow band filter with the amplifier and filter combination having an input connected to the isolated port output of the variable magnetic delay means for amplifying the clock signal and eliminating high order harmonics appearing in the clock signal input.

12. The clock and data signal recovery and generating apparatus set forth in claim 11, comprising;
narrow band splitter apparatus having an input connected to an output of narrow band amplifier and filter combination for splitting the generated clock signal and having one output for applying the generated split clock signal to the data detecting means.

13. The clock and data signal recovery and generating apparatus set forth in claim 12, wherein the data detecting means comprises;
an amplifier having an input connected to another output of the narrow band splitter apparatus for amplifying the generated split clock signal.

14. The clock and data signal recovery and generating apparatus set forth in claim 13, comprising;
a central processor unit coupled with the clock and data detecting means for controlling operation of the clock and data detecting means.

15. The clock and data signal recovery and generating apparatus set forth in claim 14, comprising;
digital converter apparatus connected by a digital bus to the central processor unit and to the clock detecting means variable magnetic delay means for converting digital signals into varying signals applied to the series network to vary a phase of the clock signal.

16. The clock and data signal recovery and generating apparatus set forth in claim 15, wherein the data detecting means comprises;
a memory device having one input connected to the other microstrip transmission line of the directional coupling means for receiving the transmission line information output of the directional coupling means and another input connected to the digital converter apparatus for receiving control signals from the central processing unit determining a magnitude for recording ones of the transmission line information and for regenerating data signals from the received transmission line information in response to the clock signal applied to a clock signal input.

17. The clock and data signal recovery and generating apparatus set forth in claim 16, wherein the data detecting means comprises;
a data detecting means narrow band amplifier having an input connected to the one output of the narrow band splitter apparatus for amplifying the generated split clock signal.

18. The clock and data signal recovery and generating apparatus set forth in claim 17, wherein the data detecting means comprises;
a data directional coupler having a pair of magnetically coupled microstrip transmission lines one of which has an input connected to the data detector narrow band amplifier and an output connected to the clock input of the memory device for applying the clock signals thereto.

19. The clock and data signal recovery and generating apparatus set forth in claim 18, wherein the data detecting means comprises;
a peak detector connected to a second one of microstrip transmission lines of the data detecting means directional coupler for detecting an absence of magnetically induced clock signals and signaling the central processing unit the absence of the magnetically induced clock signals as a loss of clock signal.

20. Apparatus for recovering and generating clock and data signals from information received on a transmission line comprising;
clock detecting means for recovering and generating a clock signal from the received transmission line information;
data detecting means enabled by the recovered clock signal for recovering and generating data contained in the received transmission line information; and
directional coupling means having a pair of magnetically coupled microstrip transmission lines positioned in a parallel relationship for magnetically coupling the transmission line information received on one microstrip line to the other microstrip line for transmission to the clock and data means

21. The clock and data signal recovery and generating apparatus set forth in claim 1, wherein the directional coupling means comprises;
a class B narrow band amplifier connected to one of the directional coupling microstrip transmission lines for receiving the magnetically coupled transmission line information and amplifying positive and negative pulses of the received transmission line information and applying the amplified pulses as a distorted sine wave to the clock detecting means.

22. The clock and data signal recovery and generating apparatus set forth in claim 21, wherein the clock detecting means comprises;
circuitry connected to an output of the class B band amplifier for defining spectral power density signals corresponding to a clock rate of the received transmission line information from the distorted sine wave and generating clock pulses therefrom.

23. The clock and data signal recovery and generating apparatus set forth in claim 22, wherein the clock detecting circuitry comprises;
a clock means directional coupler coupled to a peak detector and having magnetically coupled microstrip transmission lines for receiving the spectral power density signals and magnetically coupling the spectral power density signals to the peak detector for determining an absence of the magnetically generated power density signals as a loss of transmission line information indication.

24. The clock and data signal recovery and generating apparatus set forth in claim 23, wherein the clock detecting circuitry comprises;
a narrow band amplifier connected to the clock means directional coupler for generating the clock signals in response to receipt of the spectral power density information; and
a variable magnetic delay means connected to the narrow band amplifier and having a pair of magnetically coupled microstrip transmission lines with one microstrip transmission line having an input port connected to the narrow band amplifier for receiving the clock signals and a through port connected through a first varactor diode to ground and with another one of the microstrip transmission lines having a coupled port connected through a second varactor diode to ground and an isolated port output wherein a network having one end connected to the through port of the one microstrip transmission line and an opposite end connected to the isolated port of the other microstrip transmission line enables signals applied to a center point of the series network to vary the phase of the clock signals.

25. The clock and data signal recovery and generating apparatus set forth in claim 23, wherein the clock detecting circuitry comprises;
a combination of a narrow band amplifier coupled to a narrow band filter with the amplifier and filter combination having an input connected to the isolated port output of the variable magnetic delay means for amplifying the clock signal and for eliminating high order harmonics appearing in the clock signal input.

26. The clock and data signal recovery and generating apparatus set forth in claim 25, wherein the data detecting means comprises;
data detecting circuitry having a memory device with one input connected to the other microstrip transmission line of the directional coupler for receiving the transmission line information and another input for receiving control signals determining a magnitude for recording the transmission line information and generating data signals from the received transmission line information in response to the generated clock signal.

27. The clock and data signal recovery and generating apparatus set forth in claim 26, wherein the data detecting circuitry comprises;
a data detecting directional coupler having a pair of magnetically coupled microstrip transmission lines one of which receives the recovered clock signals for applying the received recovered clock signals to a clock input of the memory device and another one of the microstrip transmission lines for magnetically coupling the generated clock signals to a peak detector connected thereto for detecting an absence of magnetically induced clock signals as a loss of clock signal.

28. Apparatus for recovering and generating clock and data signals from information received on a transmission line, comprising;
directional coupling means having a pair of magnetically coupled microstrip transmission lines positioned in a parallel relationship for coupling a transmission line to the data and clock generating apparatus;
a class B narrow band amplifier connected to one of the directional coupling microstrip transmission lines for receiving magnetically coupled transmission line information and amplifying positive and negative pulses of the received transmission line information as a distorted sine wave;
circuitry connected to an output of the class B band amplifier for defining spectral power density signals corresponding to a clock rate of the received transmission line information and defining clock signals from the distorted sine wave;
a clock directional coupler coupled to a peak detector and having magnetically coupled microstrip transmission lines for receiving the defined clock signals and magnetically coupling the defined clock signals to the peak detector for determining an absence of the magnetically coupled defined clock signals as a loss of transmission line information indication;
a variable magnetic delay line and narrow band amplifier connected to the clock directional coupler wherein the magnetic delay line has a pair of magnetically coupled microstrip transmission lines with one microstrip transmission line having an input port connected to the narrow band amplifier for receiving the defined clock signals and a through port connected through a first varactor diode to ground and with another microstrip transmission line having a coupled port connected through a second varactor diode to ground and an isolated port output wherein a network having one end connected to the through port of the one microstrip transmission line and an opposite end connected to the isolated port of the other microstrip transmission line enables signals applied to a center point of the series network to vary the phase of the received clock signals;
a combination of a narrow band amplifier coupled to a narrow band filter with the narrow band amplifier and filter combination having an input connected to the isolated port output of the variable magnetic delay means for amplifying the clock signals and eliminating high order harmonics appearing in the clock signal input;
data detecting circuitry having a memory device with one input connected to the directional coupler means other microstrip transmission line for receiving the transmission line information output of the directional coupling means and with another input for receiving control signals determining magnitudes for recording the transmission line information and regenerating data signals from the received transmission line information in response to the generated clock signals; and
a data detecting directional coupler having a pair of magnetically coupled microstrip transmission lines one of which receives the recovered clock signals for applying the received recovered clock signals to a clock input of the memory device and another one of the microstrip transmission lines for magnetically coupling the recovered clock signals to a peak detector connected thereto for detecting an absence of magnetically induced clock signals as a loss of clock signal.

29. A magnetic delay line for delaying and varying phases of clock signals, comprising;
a pair of magnetically coupled microstrip transmission lines positioned in a parallel relationship with one microstrip transmission line having an input port for receiving the clock signals and a through port connected through a first varactor diode to ground and with another microstrip transmission line having a coupled port connected through a second varactor diode to ground and an isolated port output and having a network with one end connected to the through port of the one microstrip transmission line and an opposite end connected to the isolated port of the other microstrip transmission line for enabling signals applied to the network to vary the phase of the received clock signals.

30. A method for recovering and generating clock and data signals from received transmission line information comprising the steps of:
coupling the received transmission line information to a data detector and regenerating data appearing in the received transmission line information, and
magnetically coupling the received transmission line information to a class B amplifier coupled to a clock detector and recovering clock signals used to generate data in the transmission line information.

31. The data and clock signal regenerating and recovering method set forth in claim 30, wherein the magnetically coupling and clock signal recovering step comprises the step of
generating magnetically induced clock signals from the recovered clock signals and varying phases of the magnetically induced clock signals to delay the recovered clock signals.
